(19) United States
(12) Patent Application Publication
(10) Pub. No.: US 2024/0194875 A1
(43) Pub. Date: Jun. 13, 2024

(54) GRAPHITE ACTIVE MATERIAL, PREPARATION METHOD THEREFOR, AND HIGH-CAPACITY SECONDARY BATTERY COMPRISING SAME FOR HIGH-SPEED CHARGING AND DISCHARGING

(71) Applicant: THE INDUSTRY & ACADEMIC COOPERATION IN CHUNGNAM NATIONAL UNIVERSITY (IAC), Daejeon (KR)

(72) Inventors: Seung-Wan SONG, Sejong (KR); Thi Hai Yen TRAN, Daejeon (KR)

(21) Appl. No.: 18/286,102

(22) PCT Filed: Apr. 7, 2022
(86) PCT No.: PCT/KR2022/005038

§ 371 Date: Oct. 6, 2023

(30) Foreign Application Priority Data
Apr. 8, 2021 (KR) 10-2021-0045580
Apr. 5, 2022 (KR) 10-2022-0042207

(51) Int. Cl. H01M 4/587; C01B 32/21; H01M 4/133

(52) U.S. Cl. CPC H01M 4/587; C01B 32/21; H01M 4/133; C01P 2002/78; C01P 2006/12; C01P 2006/40

(57) ABSTRACT

A graphite active material, a method for preparing the same, and a high-capacity secondary battery for high-speed charging including the same are described. The embodiments may improve the high-speed charging performance of a secondary battery and increase the capacity thereof when using a graphite active material having an increased interlayer distance of graphite as an anode material, and may provide a secondary battery that can be mounted on small and medium-sized electronic devices such as portable phones, various electric mobilities including commercial electric vehicles, and energy storage systems (ESS).

### TECHNICAL FIELD

The present invention relates to a graphite active material, a method for preparing the same, and a high-capacity secondary battery for high-speed charging including the same.

### BACKGROUND ART

A lithium secondary battery consists of a cathode, an anode, a separator, and an electrolyte solution, and the anode is a counter electrode storing energy by intercalating and deintercalating lithium ions that are deintercalated and intercalated during charging and discharging of the cathode and moved, and completes the charge and discharge cycles of a secondary battery using lithium.

In general, a graphite anode is used in a lithium ion battery, and a staging phenomenon occurs due to the inherent characteristics of graphite having a high degree of structural order, and the lithium ion battery is charged at a slow rate until one lithium ion per six carbons is intercalated. In particular, graphite-based active materials have characteristics that are disadvantageous for high-speed use of batteries, such as requiring charging times of 20 hours or more each to achieve a theoretical capacity of 372 mAh/g.

As the commercialization of electric vehicles has recently been actively progressed, while focusing on a technology for charging the electric vehicles quickly, that is, improvement in high-speed charging performance of secondary batteries, the above-described characteristics are becoming the biggest factor that makes it difficult to apply the graphite material electrodes that most occupies the lithium secondary battery market to electric vehicle batteries.

In order to solve the above characteristics, a method for adjusting the mixture density and thickness of the graphite electrode (J. Electrochem. Soc., 152, A474-A481, 2005) has been disclosed, but the result which has performance approaching theoretical capacity even during high-speed charging of twice per hour (2C) or more in the above disclosed method and in which coulombic efficiency is good while enabling high-speed charging is obtained when the electrode active material is mixed with the current collector at a very thin thickness and in a low density.

In this case, the amount of active material mixed per area of the anode is reduced so that the energy density is lowered, the manufacturing cost is increased, and the surface area per unit weight of the active material is increased due to a decrease in the mixture density, leading to a large irreversible capacity generated during initial charging. The irreversible capacity is caused by lithium and electrons consumed in the formation of the electrochemical solid-electrolyte interface (SEI) in the anode during the first charging, and as the irreversible capacity increases, lithium supplied from the cathode is irreversibly consumed so that there is a problem in that the maximum capacity of the battery is reduced.

In order to solve the above problem, a method for preparing an anode active material for high-speed charging which is magnetically oriented while maintaining the optimization of the cathode and the anode (Nature Energy, 1, 16097, 2016) has been disclosed. The disclosed method may have advantages of obtaining an anode in which active materials are collectively orientated so that they are favored in the intercalation of ions and having a higher high-speed charging and discharging capacity compared to conventionally used electrodes without orientation by using a process of coating graphite with self-reactive iron oxide nanoparticles and a process of arranging an active material slurry placed on a metal current collector using a magnetic field. However, there is still a problem in that when performing charging and discharging (2C) twice per hour, the capacity is less than 100 mAh/g that is less than 30% of the theoretical capacity, which makes it difficult to apply the method to high-speed charging technology for electric vehicles. In addition, there is a problem in that the manufacturing cost of the battery is increased as the efficiency of the process is lowered.

That is, the above methods have high irreversible capacity, high manufacturing cost, or low high-speed charging capacity, and are not suitable for application to high-speed charging technology for electric vehicles.

Accordingly, it is necessary to develop a graphite material for the secondary battery electrode which maintains the manufacturing cost, efficiency, and optimization of a common secondary battery and is suitable for high-speed charging.

### RELATED ART DOCUMENTS

### Non-Patent Documents

(0001) Hilmi Buqa et al., High rate capability of graphite negative electrodes for Lithium-Ion batteries, J. Electrochem. Soc., 152, A474-A481, 2005
(0002) Juliette Billaud, Florian Bouville et al., Magnetically aligned graphite electrodes for high-rate performance Li-ion batteries, Nature Energy, 1, 16097, 2016

### DISCLOSURE

### Technical Problem

In order to solve the above problems, an object of the present invention is to improve the high-speed charging and discharging performance of a secondary battery and increase the capacity thereof when using a graphite active material having an increased interlayer distance of graphite as an anode material.

Further, another object of the present invention is to provide a secondary battery that can be mounted on small and medium-sized electronic devices such as portable phones, various electric mobilities including commercial electric vehicles, and energy storage systems (ESS).

### Technical Solution

In order to achieve the above object, the present invention relates to a graphite active material having an interlayer distance d₀₀₂ increased by 0.001 Å to 0.003 Å.

The graphite active material may be a natural graphite active material or an artificial graphite active material.

The lithium secondary battery including the natural graphite active material as an electrode active material may have an initial Coulombic efficiency of 90 to 95%, a discharge capacity per weight of 360 mAh/g or more during 0.1 C charging, and a capacity retention rate of 30 to 99% during 2 C charging.

The lithium secondary battery including the graphite active material as an electrode active material has a discharge capacity per weight of 320 mAh/g or more during 1 C (charging within 1 hour) charging a, and enables a 1 C charge.

The artificial graphite active material may have an interlayer distance d₀₀₂ of 3.368 Å to 3.370 Å.

The lithium secondary battery including the artificial graphite active material as an electrode active material may have an initial Coulombic efficiency of 65 to 92%, a discharge capacity per weight of 345 to 360 mAh/g during 0.1 C charging, and a capacity retention rate of 10 to 45% during 2 C charging.

The graphite active material may have a BET specific surface area increased by 127% or more.

An electrode for a secondary battery according to another embodiment of the present invention may include the graphite active material.

The electrode for a secondary battery may be a cathode material or an anode material of the secondary battery.

A secondary battery according to another embodiment of the present invention may include the electrode for a secondary battery.

A method for preparing a graphite active material according to another embodiment of the present invention includes the steps of: supporting graphite in an organic solvent; low-temperature treating graphite supported in the organic solvent; and drying low-temperature treated graphite, wherein the graphite active material may have an interlayer distance d₀₀₂ increased by 0.001 Å to 0.003 Å.

The organic solvent may be selected from the group consisting of a linear alcohol-based organic solvent, a linear carbonate-based organic solvent, a cyclic carbonate-based organic solvent, a linear ester-based organic solvent, a ketone-based organic solvent, and mixtures thereof.

The low-temperature treatment may be performed at 0 to −40° C. for 0.1 to 168 hours.

### Advantageous Effects

Unlike graphite active materials included in a conventional electrode for a secondary battery, the graphite active material according to the present invention can greatly improve high-speed charging a performance of the secondary battery when used as the electrode for a secondary battery by increasing the distance between graphite layers. In addition, since the secondary battery has higher Coulombic efficiency than conventional secondary batteries and thus can reduce irreversible capacity, a decrease in capacity of a full cell is suppressed so that a capacity approaching the theoretical capacity of the battery can be used.

The secondary battery provided by the present invention has compatibility with materials widely used in the existing lithium secondary battery market so that it has a low manufacturing cost, and does not require separate optimization.

In addition, the secondary battery provided by the present invention improves high-speed charging performance and performance per weight, which are reasons why it is difficult to apply existing secondary batteries to electric vehicles, thereby enabling high-speed charging and weight reduction, which are key elements in the electric vehicle technology development, to be simultaneously achieved.

### BRIEF DESCRIPTION OF DRAWING

FIG. 1 is a result of measuring electrochemical impedance spectroscopy (EIS) during a formation process and initial charging of a lithium half-cell according to one embodiment of the present invention.

### BEST MODE

The present invention relates to a graphite active material having an interlayer distance d₀₀₂ increased by 0.001 Å to 0.003 Å.

### MODE FOR INVENTION

Hereinafter, embodiments of the present invention will be described in detail so that those skilled in the art to which the present invention pertains can easily carry out the present invention. However, the present invention may be embodied in a variety of different forms and is not limited to the embodiments described herein.

The anode material included in a lithium secondary battery accounts for about 15% of the material cost of a lithium ion battery, and is the third after a cathode material and a separator, but it is a counter electrode material for cathode materials, and is a key material that determines the performance such as battery capacity.

Types of currently used graphite anode material types may be classified into natural graphite and artificial graphite.

Since an anode material prepared using natural graphite is produced and processed from underground resources and then prepared, its price competitiveness is superior to artificial graphite, and the initial charging efficiency is 90% or more due to the development of surface treatment or spheronization technology so that its amount of use is expanding.

The anode material prepared using artificial graphite is prepared by performing firing and carbonization treatment of cokes and pitch as raw materials and heating them again in an electric furnace at a high temperature of up to 3,000° ° C. so that it may have a more excellent lifespan than natural graphite, but may be less competitive in price than natural graphite.

However, as described above, the graphite active material has problems in that a staging phenomenon occurs due to the inherent characteristics of graphite having a high degree of structural order, and a charging speed is slow until one lithium ion per six carbons is intercalated. In particular, graphite-based active materials have characteristics that are disadvantageous for high-speed use of batteries, such as requiring charging and discharging times of 20 hours or more each to achieve a theoretical capacity of 372 mAh/g.

In order to solve these problems, anode active materials have been tried to be prepared by various methods such as conventional surface treatment or spheronization process, high-temperature treatment of 1,200° C. or more, and the like, but since they have a high manufacturing cost or a low high-speed charging capacity, there is a problem in that it is not suitable for applying the methods to high-speed charging technology of electric vehicles for long-distance driving.

Accordingly, the present invention is characterized in that the high-speed charging and discharging cycle performance of a secondary battery is improved, and the capacity thereof is increased by using a conventionally used graphite active material that has not been subjected to separate surface treatment or spheronization process.

Specifically, the graphite active material according to one embodiment of the present invention is characterized by having an interlayer distance d₀₀₂ increased by 0.001 Å to 0.003 Å.

The graphite active material is characterized in that it has a layered structure in terms of crystal structure.

Specifically, in the crystal structure of graphite, carbon atoms in sp² hybrid orbitals combine with each other in a hexagonal plane to form a carbon hexagonal plane (graphene layer), and π electrons positioned on the top and bottom of the carbon plane bind the carbon hexagonal plane.

Since the π electrons can be relatively freely moved between carbon hexagonal planes, they have excellent electronic conductivity of graphite. The π bond bonding between such graphite layers forms a weak van der Waals bond, but the bond inside the carbon hexagonal plane is made up of a very strong covalent bond to show anisotropy. Lithium ions are intercalated and deintercalated between such graphite layers. Graphite active material basically means hexagonal graphite in which graphite layer planes are stacked in the ABAB method in the c-axis direction, but the stacking order may be partially modified to include rhombohedral graphite structure in which the graphite layer planes are stacked in the ABCABC method.

The graphite active material is subjected to a reduction reaction during charging so that, when lithium ions are intercalated into the layered structure of graphite, a compound of LiₓC is formed, and at this time, the interlayer stacking method is changed to the AAAA method. Meanwhile, during discharging, lithium ions are deintercalated while an oxidation reaction occurs in graphite.

During charging and discharging as described above, electrochemical properties such as reaction potential and lithium storage capacity may differ depending on crystallinity, microstructure, and particle shape of the graphite active material.

However, in general, the interlayer distance door in the crystal structure of the graphite active material may be 3.359 to 3.367 Å in the case of artificial graphite, and may be 3.355 to 3.550 Å in the case of natural graphite. However, in the case of natural graphite, since it is not artificially manufactured, the interlayer distance is not limited to the above-described range and may vary.

Within the interlayer distance as described above, lithium ions are intercalated during charging and deintercalated during discharging.

Accordingly, in the present invention, the interlayer distance door of the graphite active material is increased by 0.001 Å to 0.003 Å, and thus the charging speed and charging capacity may be increased.

As described above, when charging the lithium secondary battery, the mechanism is that lithium ions are intercalated into the layered structure of the graphite active material, which is an anode material, to form a LiₓC compound.

Therefore, as in the present invention, when the interlayer distance d₀₀₂ of the graphite active material is increased by 0.001 Å to 0.003 Å, the intercalation of lithium ions is smoothly performed, and as the amount of lithium ions that can be intercalated increases, the charging capacity of the lithium secondary battery may be increased.

The graphite active material according to one embodiment of the present invention is an artificial graphite active material, and the artificial graphite active material may have an interlayer distance d₀₀₂ of 3.368 Å to 3.370 Å. A general artificial graphite active material has an interlayer distance d₀₀₂ of 3.359 to 3.367 Å, and the artificial graphite active material of the present invention has an interlayer distance door of an artificial graphite active material, which is used as an existing anode material, increased by 0.001 to 0.002 Å.

The lithium secondary battery including the artificial graphite active material as an electrode active material may have an initial Coulombic efficiency of 65 to 92%, a discharge capacity per weight of 345 to 360 mAh/g during 0.1 C charging and discharging, and a capacity retention rate of 10 to 45% during 2 C charging and discharging.

The lithium secondary battery including the artificial graphite active material as an electrode active material may have an initial Coulombic efficiency of 65 to 92%, preferably 75 to 90%, and more preferably 82 to 88%.

The lithium secondary battery including the artificial graphite active material as an electrode active material may have a discharge capacity per weight of 330 to 370 mAh/g, preferably 338 to 365 mAh/g, and more preferably 345 to 360 mAh/g during 0.1 C charging and discharging.

The lithium secondary battery including the artificial graphite active material as an electrode active material may have a capacity retention rate of 10 to 30%, preferably 13 to 28.5%, and more preferably 18 to 27% during 2 C charging and discharging.

The graphite active material is a natural graphite active material, and the natural graphite active material may have an interlayer distance d₀₀₂ of 3.362 Å to 3.363 Å.

The general natural graphite active material has an interlayer distance d₀₀₂ of 3.355 to 3.550 Å, and the natural graphite active material of the present invention has an interlayer distance d₀₀₂ of a natural graphite active material, which is used as an existing anode material, increased by 0.002 to 0.003 Å.

The lithium secondary battery including the graphite active material as an electrode active material has a discharge capacity per weight of 320 mAh/g or more during 1 C (charging within 1 hour) charging, and enables a 1 C charge cycle.

The lithium secondary battery including the natural graphite active material as an electrode active material may have a discharge capacity per weight of 370 to 395 mAh/g, preferably 380 to 394 mAh/g, and more preferably 385 to 393 mAh/g during 0.1 C charging.

The lithium secondary battery including the natural graphite active material as an electrode active material may have a capacity retention rate of 30 to 99%, preferably 35 to 99%, and more preferably 50 to 99% during 2 C charging and discharging.

As described above, the increase in the interlayer distance door of the graphite active material can be more clearly confirmed through the increase in the specific surface area.

The graphite active material is characterized by having a BET specific surface area increased by 127% or more. Specifically, the artificial graphite active material has a BET specific surface area increased by 127% to 130%, and the natural graphite active material has a BET specific surface area increased by 127% to 150%.

As described above, the increase in the interlayer distance d₀₀₂ and the BET specific surface area of the graphite active material may increase the interlayer distance of the crystal structure, thereby increasing, during charging, the intercalation rate of lithium ions and increasing the charging capacity.

However, when the interlayer distance increases beyond the above-described range, there is a problem in that lithium ions cannot be fixed between the graphite layers, and when the distance increases below the above-described range, an effect of increasing the charging speed and an effect of increasing the charging capacity according to the increase in the interlayer distance may be inadequate.

Another embodiment of the present invention relates to a method for preparing a graphite active material, the method including the steps of: supporting graphite in an organic solvent; low-temperature treating graphite supported in the organic solvent; and drying low-temperature treated graphite, wherein the graphite active material may have an interlayer distance d₀₀₂ increased by 0.001 Å to 0.003 Å.

Graphite is a natural graphite active material or artificial graphite active material that can be used as a graphite active material, but is not limited to the above examples, and any material that can be used as the graphite active material can be used without limitation.

The organic solvent may be selected from the group consisting of a linear alcohol-based organic solvent, a linear carbonate-based organic solvent, a cyclic carbonate-based organic solvent, a linear ester-based organic solvent, a ketone-based organic solvent, and mixtures thereof.

The alcohol-based organic solvent may be methyl alcohol, ethyl alcohol, propyl alcohol, 2-propyl alcohol, 1-butyl alcohol, 2-butyl alcohol, isobutyl alcohol, tert-butyl alcohol, or the like.

The linear carbonate-based organic solvent may be dimethyl carbonate, ethyl methyl carbonate, diethyl carbonate, methyl propyl carbonate, ethyl propyl carbonate, dipropyl carbonate, or the like.

The cyclic carbonate-based organic solvent may be ethylene carbonate (EC), propylene carbonate (PC), or the like.

In addition, fluorinated cyclic carbonate-based organic solvents such as fluoroethylene carbonate (FEC), 4,4-difluoroethylene carbonate, 4,5-difluoroethylene carbonate, 4-methyl-5-fluoroethylene carbonate, 4-methyl-5,5-difluoroethylene carbonate, 4-(fluoromethyl)ethylene carbonate, 4-(difluoromethyl)ethylene carbonate, 4-(trifluoromethyl)ethylene carbonate, 4-(2-fluoroethyl)ethylene carbonate, 4-(2,2-difluoroethyl)ethylene carbonate, and 4-(2,2,2-trifluoroethyl)ethylene carbonate may also be used.

Fluorinated dimethyl carbonate-based organic solvents such as fluoromethylmethyl carbonate, difluoromethylmethyl carbonate, trifluoromethylmethyl carbonate, bis(fluoromethyl) carbonate, bis(difluoromethyl) carbonate, bis(trifluoromethyl) carbonate, (fluoromethyl)(difluoromethyl) carbonate, (fluoromethyl)(trifluoromethyl) carbonate, and (difluoromethyl)(trifluoromethyl) carbonate may also be used.

Fluorinated diethyl carbonate-based organic solvents such as 2-fluoroethylethyl carbonate, 2,2-difluoroethylethyl carbonate, 2,2,2-trifluoroethylethyl carbonate, bis(2-fluoroethyl) carbonate, bis(2,2-difluoroethyl) carbonate, bis(2,2,2-trifluoroethyl) carbonate, (2-fluoroethyl)(2,2-difluoroethyl) carbonate, (2-fluoroethyl)(2,2,2-trifluoroethyl) carbonate, and (2,2-difluoroethyl)(2,2,2-trifluoroethyl) carbonate may also be used.

Fluorinated ethylmethyl carbonate-based organic solvents such as 2-fluoroethylmethyl carbonate, 2,2-difluoroethylmethyl carbonate, 2,2,2-trifluoroethylmethyl carbonate, (2-fluoroethyl)(fluoromethyl) carbonate, (2-fluoroethyl)(difluoromethyl) carbonate, (2-fluoroethyl)(trifluoromethyl) carbonate, (2,2-difluoroethyl)(fluoromethyl) carbonate, (2,2-difluoroethyl)(difluoromethyl) carbonate, (2,2-difluoroethyl)(trifluoromethyl) carbonate, (2,2,2-trifluoroethyl)(fluoromethyl) carbonate, (2,2,2-trifluoroethyl)(difluoromethyl) carbonate, and (2,2,2-trifluoroethyl)(trifluoromethyl) carbonate may also be used.

The linear ester-based organic solvent may be methyl acetate, ethyl acetate, methyl propionate, ethyl propionate, or the like.

In addition, fluorinated linear ester-based organic solvents such as fluoromethyl acetate, difluoromethyl acetate, trifluoromethyl acetate, 2-fluoroethyl acetate, 2,2-difluoroethyl acetate, 2,2,2-trifluoroethyl acetate, fluoromethyl propionate, difluoromethyl propionate, trifluoromethyl propionate, 2-fluoroethyl propionate, 2,2-difluoroethyl propionate, and 2,2,2-trifluoroethyl propionate may also be used.

The ketone-based organic solvent may be acetone, methyl ethyl ketone, diethyl ketone, or the like.

In addition, fluorinated ketone-based organic solvents such as 1-fluoropropan-2-one, 1,1-difluoropropan-2-one, 1,1,1-trifluoropropan-2-one, 1,3-difluoropropan-2-one, 1,1,3-trifluoropropan-2-one, 1,1,1,3-tetrafluoropropan-2-one, 1,1,3,3-tetrafluoropropan-2-one, 1,1,1,3,3-pentafluoropropan-2-one, and 1,1,1,3,3,3-hexafluoropropan-2-one may also be used.

The solvent for supporting graphite is different depending on artificial graphite or natural graphite. Specifically, it is particularly preferable to use ethyl methyl carbonate (EMC) as a solvent for supporting artificial graphite, and ethanol is particularly preferable as the solvent for supporting natural graphite.

The low-temperature treatment may be performed at a temperature of 0 to −40° C. for 0.1 to 168 hours. At this time, the temperature is preferably −5 to −35° C., more preferably −10 to −30° ° C.

When the graphite active material is treated under the supported solvent and low-temperature treatment conditions as described above, the interlayer distance of the graphite active material increases so that when used as an anode material for a lithium secondary battery, the charging speed can be improved, and the charging capacity can be increased.

Another embodiment of the present invention relates to an electrode for a secondary battery including a graphite active material and a secondary battery including the same.

The graphite active material may be usable as a cathode material or anode material of a secondary battery.

Specifically, the graphite active material may be processed by being included in the electrode for a secondary battery along with a conductive material and a binder through a method commonly practiced in the art.

The conductive material is used to impart conductivity to the electrode, and can be used without particular limitation as long as it does not cause chemical change and has electronic conductivity. Specific examples thereof may include: carbon-based materials such as graphite, carbon black, Super P, acetylene black, Ketjen black, channel black, furnace black, lamp black, summer black, carbon fiber, carbon nanotubes, carbon nanowires, graphene, graphitized mesocarbon microbeads, fullerene, and amorphous carbon; metal powders or metal fibers such as copper, nickel, aluminum, and silver; conductive whiskers such as zinc oxide and potassium titanate; conductive metal oxides such as titanium oxide; or conductive polymers such as polyphenylene derivatives, and one of these alone or mixtures of two or more thereof may be used, but these conductive materials are only examples and are not limited as long as they are previously known conductive materials.

The binder improves adhesive force between the active material and the conductive material particles or between the active material and the current collector. Specific examples thereof may include polyvinylidene fluoride (PVDF), polyimide (PI), fluoropolyimide (FPI), polyacrylic acid (PAA), polyvinyl alcohol (PVA), carboxymethyl cellulose (CMC), starch, hydroxypropyl cellulose, regenerated cellulose, polyvinylpyrrolidone (PVP), tetrafluoroethylene, polyethylene, polypropylene, polyurethane, ethylene propylene diene monomer (EPDM), sulfonated-EPDM, styrene-butadiene rubber, fluororubber, or copolymers thereof, algin, etc., and one of these alone or mixtures of two or more thereof may be used, but these binders are only examples and are not limited as long as they are previously known binders.

The graphite active material may be used as an anode material of a lithium secondary battery. The anode material of the lithium secondary battery intercalates and stores lithium during battery charging, and provides electrical energy by deintercalating lithium during battery discharging.

The lithium secondary battery may further include: a cathode for a lithium secondary battery; an electrolyte for a lithium secondary battery; and a separator.

As a cathode active material in the cathode for a lithium secondary battery, any one or mixtures of two or more selected from LiCoO₂, LiMnO₂, LiNiO₂, LiMn₂O₄, LiNi₁₋ₓCoₓO₂, LiNiₓCo_{y}Mn_{z}O₂ (x+y+z=1), LiNiₓCo_{y}Al_{z}O₂ (x+y+z=1), LiNiₓMn_{y}M_{z}O₂ (x+y+z=1, and M is a divalent or trivalent metal or transition metal), LiFePO₄, LiMnPO₄, LiCoPO₄, LiFe₁₋ₓMₓPO₄ (M is a transition metal), a(Li₂MnO₃)b(LiNIₓCo_{y}Mn_{z}O₂) (a+b=1, x+y+z=1), Li_{1.2}Ni_{0.13}Co_{0.13-x}Mn_{0.54}AlₓO_{2(1-y)}F_{2y} (x and y are mutually independent real numbers from 0 to 0.05), Li_{1.2}Mn_{(0.8-a)}MaO₂ (M is a divalent or trivalent metal or transition metal), Li₂N₁₋ₓMₓO₃ (N is a divalent, trivalent or tetravalent metal or transition metal, and M is a divalent or trivalent metal or transition metal), Li₁₊ₓN_{y-z}M_{z}O₂ (N is Ti or Nb, and M is V, Ti, Mo, or W), Li₄Mn₂₋ₓMₓO₅ (M is a metal or transition metal), LiₓM₂₋ₓO₂ (M is a metal or transition metal such as Ti, Zr, Nb, Mn, or the like), and Li₂O/Li₂Ru₁₋ₓMₓO₃ (M is a metal or transition metal) may be used, but these cathode active materials are only examples and are not limited as long as they are previously known cathode active materials.

In addition, the cathode for a lithium secondary battery may further include a conductive material and a binder, which are the same as the above-described conductive material and binder so that overlapping descriptions are omitted.

The electrolyte for a lithium secondary battery may be made of: a lithium salt and a mixed organic solvent containing the same; a polymer matrix; or an all-solid electrolyte.

The lithium salt may be any one or mixtures of two or more selected from the group consisting of LiPF₆, LiClO₄, LiAsF₆, LiBF₄, LiSbF₆, LiAlO₄, LiAlCl₄, LiCF₃SO₃, LiC₄F₉SO₃, LiC₆H₅SO₃, LiN(C₂F₅SO₃)₂, LiN(C₂F₅SO₂)₂, LiN(CF₃SO₂)₂, LiN(FSO₂)₂, LiN(CₓF₂ₓ₊₁SO₂)(C_{y}F_{2y+1}SO₂) (provided that x and y are 0 or natural numbers), LiCl, LiI, LiSCN, LiB(C₂O₄)₂, LiF₂BC₂O₄, LiPF₄(C₂O₄), LiPF₂(C₂O₄)₂, and LiP(C₂O₄)₃, which are only examples and can be used without particular limitation as long as they are commonly used in the art and thus the lithium salt is not necessarily limited thereto.

The mixed organic solvent may be any one or mixtures of two or more selected from: a group consisting of cyclic carbonate-based compounds such as ethylene carbonate, propylene carbonate, and vinylene carbonate;
a group consisting of fluorinated cyclic carbonate-based compounds such as fluoroethylene carbonate, difluoroethylene carbonate, and fluoropropylene carbonate;
a group consisting of linear carbonate-based compounds such as dimethyl carbonate, methyl ethyl carbonate, and diethyl carbonate;
a group consisting of fluorinated dimethyl carbonate-based compounds such as fluoromethylmethyl carbonate, difluoromethylmethyl carbonate, trifluoromethylmethyl carbonate, bis(fluoromethyl) carbonate, bis(difluoromethyl) carbonate, bis(trifluoromethyl) carbonate, (fluoromethyl)(difluoromethyl) carbonate, (fluoromethyl)(trifluoromethyl) carbonate, and (difluoromethyl)(trifluoromethyl) carbonate;
a group consisting of fluorine-containing ethylmethyl carbonate-based compounds such as 2-fluoroethylmethyl carbonate, 2,2-difluoroethylmethyl carbonate, 2,2,2-trifluoroethylmethyl carbonate, (2-fluoroethyl)(fluoromethyl) carbonate, (2-fluoroethyl)(difluoromethyl) carbonate, (2-fluoroethyl)(trifluoromethyl) carbonate, (2,2-difluoroethyl)(fluoromethyl) carbonate, (2,2-difluoroethyl)(difluoromethyl) carbonate, (2,2-difluoroethyl)(trifluoromethyl) carbonate, (2,2,2-trifluoroethyl)(fluoromethyl) carbonate, (2,2,2-trifluoroethyl)(difluoromethyl) carbonate, and (2,2,2-trifluoroethyl)(trifluoromethyl) carbonate; and a group consisting of fluorinated diethyl carbonate-based compounds such as 2-fluoroethylethyl carbonate, 2,2-difluoroethylethyl carbonate, 2,2,2-trifluoroethylethyl carbonate, bis(2-fluoroethyl) carbonate, bis(2,2-difluoroethyl) carbonate, bis(2,2,2-trifluoroethyl) carbonate, (2-fluoroethyl)(2,2-difluoroethyl) carbonate, (2-fluoroethyl)(2,2,2-trifluoroethyl) carbonate, and (2,2-difluoroethyl)(2,2,2-trifluoroethyl) carbonate;
a group consisting of fluorinated ester-based compounds such as fluoromethyl acetate, difluoromethyl acetate, trifluoromethyl acetate, 2-fluoroethyl acetate, 2,2-difluoroethyl acetate, 2,2,2-trifluoroethyl acetate, fluoromethyl propionate, difluoromethyl propionate, trifluoromethyl propionate, 2-fluoroethyl propionate, 2,2-difluoroethyl propionate, 2,2,2-trifluoroethyl propionate, 2-fluoroethyl butyrate, 2,2-difluoroethyl butyrate, and 2,2,2-trifluoroethyl butyrate (TFEB);
a group consisting of ether-based compounds such as dimethyl ether, ethylmethyl ether, diethyl ether, propylmethyl ether, propylethyl ether, dipropyl ether, isopropylmethyl ether, isopropylethyl ether, diisopropyl ether, n-butylmethyl ether, n-butylethyl ether, n-butylpropyl ether, n-butylisopropyl ether, n-dibutyl ether, tert-butylmethyl ether, tert-butylethyl ether, tert-butylpropyl ether, tert-butylisopropyl ether, tert-dibutyl ether, ethylene glycol methyl ether, ethylene glycol ethyl ether, ethylene glycol propyl ether, ethylene glycol isopropyl ether, ethylene glycol n-butyl ether, ethylene glycol tert-butyl ether, diethylene glycol ether, propylene glycol methyl ether, propylene glycol ethyl ether, propylene glycol propyl ether, propylene glycol isopropyl ether, propylene glycol n-butyl ether, propylene glycol tert-butyl ether, and dipropylene glycol ether;
a group consisting of fluorinated ethers such as fluoromethyl methyl ether, difluoromethyl methyl ether, trifluoromethyl methyl ether, di(fluoromethyl) ether, difluoromethyl fluoromethyl ether, trifluoromethyl fluoromethyl ether, di(difluoromethyl) ether, trifluoromethyl difluoromethyl ether, di(trifluoromethyl) ether, 1-fluoroethyl methyl ether, 2-fluoroethyl methyl ether, 1,1-difluoroethyl methyl ether, 1,2-difluoroethyl methyl ether, 2,2-difluoroethyl methyl ether, 1,1,1-trifluoroethyl methyl ether, 1,1,2-trifluoroethyl methyl ether, 1,2,2-trifluoroethyl methyl ether, 2,2,2-trifluoroethyl methyl ether, 1,1,1,2-tetrafluoroethyl methyl ether, 1,1,2,2-tetrafluoroethyl methyl ether, 1,2,2,2-tetrafluoroethyl methyl ether, 1,1,1,2,2-pentafluoroethyl methyl ether, 1,1,2,2,2-pentafluoroethyl methyl ether, hexafluoroethyl methyl ether, 1-fluoroethyl fluoromethyl ether, 2-fluoroethyl fluoromethyl ether, 1,1-difluoroethyl fluoromethyl ether, 1,2-difluoroethyl fluoromethyl ether, 2,2-difluoroethyl fluoromethyl ether, 1,1,1-trifluoroethyl fluoromethyl ether, 1,1,2-trifluoroethyl fluoromethyl ether, 1,2,2-trifluoroethyl fluoromethyl ether, 2,2,2-trifluoroethyl fluoromethyl ether, 1,1,1,2-tetrafluoroethyl fluoromethyl ether, 1,1,2,2-tetrafluoroethyl fluoromethyl ether, 1,2,2,2-tetrafluoroethyl fluoromethyl ether, 1,1,1,2,2-pentafluoroethyl fluoromethyl ether, 1,1,2,2,2-pentafluoroethyl fluoromethyl ether, hexafluoroethyl fluoromethyl ether, 1-fluoroethyl difluoromethyl ether, 2-fluoroethyl difluoromethyl ether, 1,1-difluoroethyl difluoromethyl ether, 1,2-difluoroethyl difluoromethyl ether, 2,2-difluoroethyl difluoromethyl ether, 1,1,1-trifluoroethyl difluoromethyl ether, 1,1,2-trifluoroethyl difluoromethyl ether, 1,2,2-trifluoroethyl difluoromethyl ether, 2,2,2-trifluoroethyl difluoromethyl ether, 1,1,1,2-tetrafluoroethyl difluoromethyl ether, 1,1,2,2-tetrafluoroethyl difluoromethyl ether, 1,2,2,2-tetrafluoroethyl difluoromethyl ether, 1,1,1,2,2-pentafluoroethyl difluoromethyl ether, 1,1,2,2,2-pentafluoroethyl difluoromethyl ether, hexafluoroethyl difluoromethyl ether, 1-fluoroethyl trifluoromethyl ether, 2-fluoroethyl trifluoromethyl ether, 1,1-difluoroethyl trifluoromethyl ether, 1,2-difluoroethyl trifluoromethyl ether, 2,2-difluoroethyl trifluoromethyl ether, 1,1,1-trifluoroethyl trifluoromethyl ether, 1,1,2-trifluoroethyl trifluoromethyl ether, 1,2,2-trifluoroethyl trifluoromethyl ether, 2,2,2-trifluoroethyl trifluoromethyl ether, 1,1,1,2-tetrafluoroethyl trifluoromethyl ether, 1,1,2,2-tetrafluoroethyl trifluoromethyl ether, 1,2,2,2-tetrafluoroethyl trifluoromethyl ether, 1,1,1,2,2-pentafluoroethyl trifluoromethyl ether, 1,1,2,2,2-pentafluoroethyl trifluoromethyl ether, hexafluoroethyl trifluoromethyl ether, 1-fluoroethyl ethyl ether, 2-fluoroethyl ethyl ether, 1,1-difluoroethyl ethyl ether, 1,2-difluoroethyl ethyl ether, 2, 2-difluoroethyl ethyl ether, 1,1,1-trifluoroethyl ethyl ether, 1,1,2-trifluoroethyl ethyl ether, 1,2,2-trifluoroethyl ethyl ether, 2,2,2-trifluoroethyl ethyl ether, 1,1,1,2-tetrafluoroethyl ethyl ether, 1,1,2,2-tetrafluoroethyl ethyl ether, 1,2,2,2-tetrafluoroethyl ethyl ether, 1,1,1,2,2-pentafluoroethyl ethyl ether, 1,1,2,2,2-pentafluoroethyl ethyl ether, hexafluoroethyl ethyl ether, 1-fluoroethyl ether, 2-fluoroethyl 1-fluoroethyl ether, 1,1-difluoroethyl 1-fluoroethyl ether, 1,2-difluoroethyl 1-fluoroethyl ether, 2,2-difluoroethyl 1-fluoroethyl ether, 1,1,1-trifluoroethyl 1-fluoroethyl ether, 1,1,2-trifluoroethyl 1-fluoroethyl ether, 1,2,2-trifluoroethyl 1-fluoroethyl ether, 2,2,2-trifluoroethyl 1-fluoroethyl ether, 1,1,1,2-tetrafluoroethyl 1-fluoroethyl ether, 1,1,2,2-tetrafluoroethyl 1-fluoroethyl ether, 1,2,2,2-tetrafluoroethyl 1-fluoroethyl ether, 1,1,1,2,2-pentafluoroethyl 1-fluoroethyl ether, 1,1,2,2,2-pentafluoroethyl 1-fluoroethyl ether, hexafluoroethyl 1-fluoroethyl ether, 1-fluoroethyl 2-fluoroethyl ether, 2-fluoroethyl ether, 1,1-difluoroethyl 2-fluoroethyl ether, 1,2-difluoroethyl 2-fluoroethyl ether, 2,2-difluoroethyl 2-fluoroethyl ether, 1,1,1-trifluoroethyl 2-fluoroethyl ether, 1,1,2-trifluoroethyl 2-fluoroethyl ether, 1,2,2-trifluoroethyl 2-fluoroethyl ether, 2,2,2-trifluoroethyl 2-fluoroethyl ether, 1,1,1,2-tetrafluoroethyl 2-fluoroethyl ether, 1,1,2,2-tetrafluoroethyl 2-fluoroethyl ether, 1,2,2,2-tetrafluoroethyl 2-fluoroethyl ether, 1,1,1,2,2-pentafluoroethyl 2-fluoroethyl ether, 1,1,2,2,2-pentafluoroethyl 2-fluoroethyl ether, hexafluoroethyl 2-fluoroethyl ether, 1-fluoroethyl 1,2-difluoroethyl ether, 2-fluoroethyl 1,2-difluoroethyl ether, 1,1-difluoroethyl 1,2-difluoroethyl ether, di(1,2-difluoroethyl) ether, 2,2-difluoroethyl 1,2-difluoroethyl ether, 1,1,1-trifluoroethyl 1,2-difluoroethyl ether, 1,1,2-trifluoroethyl 1,2-difluoroethyl ether, 1,2,2-trifluoroethyl 1,2-difluoroethyl ether, 2,2,2-trifluoroethyl 1,2-difluoroethyl ether, 1,1,1,2-tetrafluoroethyl 1,2-difluoroethyl ether, 1,1,2,2-tetrafluoroethyl 1,2-difluoroethyl ether, 1,2,2,2-tetrafluoroethyl 1,2-difluoroethyl ether, 1,1,1,2,2-pentafluoroethyl 1,2-difluoroethyl ether, 1,1,2,2,2-pentafluoroethyl 1,2-difluoroethyl ether, hexafluoroethyl 1,2-difluoroethyl ether, 1,1-difluoroethyl 2,2-difluoroethyl ether, 1,2-difluoroethyl 2,2-difluoroethyl ether, di(2,2-difluoroethyl) ether, 1,1,1-trifluoroethyl 2,2-difluoroethyl ether, 1,1,2-trifluoroethyl 2,2-difluoroethyl ether, 1,2,2-trifluoroethyl 2,2-difluoroethyl ether, 2,2,2-trifluoroethyl 2,2-difluoroethyl ether, 1,1,1,2-tetrafluoroethyl 2,2-difluoroethyl ether, 1,1,2,2-tetrafluoroethyl 2,2-difluoroethyl ether, 1,2,2,2-tetrafluoroethyl 2,2-difluoroethyl ether, 1,1,1,2,2-pentafluoroethyl 2,2-difluoroethyl ether, 1,1,2,2,2-pentafluoroethyl 2,2-difluoroethyl ether, hexafluoroethyl 2,2-difluoroethyl ether, 1,1-difluoroethyl 1,1,1-trifluoroethyl ether, 1,2-difluoroethyl 1,1,1-trifluoroethyl ether, 2,2-difluoroethyl 1,1,1-trifluoroethyl ether, di(1,1,1-trifluoroethyl) ether, 1,1,2-trifluoroethyl 1,1,1-trifluoroethyl ether, 1,2,2-trifluoroethyl 1,1,1-trifluoroethyl ether, 2,2,2-trifluoroethyl 1,1,1-trifluoroethyl ether, 1,1,1,2-tetrafluoroethyl 1,1,1-trifluoroethyl ether, 1,1,2,2-tetrafluoroethyl 1,1,1-trifluoroethyl ether, 1,2,2,2-tetrafluoroethyl 1,1,1-trifluoroethyl ether, 1,1,1,2,2-pentafluoroethyl 1,1,1-trifluoroethyl ether, 1,1,2,2,2-pentafluoroethyl 1,1,1-trifluoroethyl ether, hexafluoroethyl 1,1,1-trifluoroethyl ether, 1,1-difluoroethyl 1,1,2-trifluoroethyl ether, 1,2-difluoroethyl 1,1,2-trifluoroethyl ether, 2,2-difluoroethyl 1,1,2-trifluoroethyl ether, 1,1,1-trifluoroethyl 1,1,2-trifluoroethyl ether, 1,1,2-trifluoroethyl ether, 1,2,2-trifluoroethyl 1,1,2-trifluoroethyl ether, 2,2,2-trifluoroethyl 1,1,2-trifluoroethyl ether, 1,1,1,2-tetrafluoroethyl 1,1,2-trifluoroethyl ether, 1,1,2,2-tetrafluoroethyl 1,1,2-trifluoroethyl ether, 1,2,2,2-tetrafluoroethyl 1,1,2-trifluoroethyl ether, 1,1,1,2,2-pentafluoroethyl 1,1,2-trifluoroethyl ether, 1,1,2,2,2-pentafluoroethyl 1,1,2-trifluoroethyl ether, hexafluoroethyl 1,1,2-trifluoroethyl ether, 1,1-difluoroethyl 1,2,2-trifluoroethyl ether, 1,2-difluoroethyl 1,2,2-trifluoroethyl ether, 2,2-difluoroethyl 1,2,2-trifluoroethyl ether, 1,1,1-trifluoroethyl 1,2,2-trifluoroethyl ether, 1,1,2-trifluoroethyl 1,2,2-trifluoroethyl ether, di(1,2,2-trifluoroethyl) ether, 2,2,2-trifluoroethyl 1,2,2-trifluoroethyl ether, 1,1,1,2-tetrafluoroethyl 1,2,2-trifluoroethyl ether, 1,1,2,2-tetrafluoroethyl 1,2,2-trifluoroethyl ether, 1,2,2,2-tetrafluoroethyl 1,2,2-trifluoroethyl ether, 1,1,1,2,2-pentafluoroethyl 1,2,2-trifluoroethyl ether, 1,1,2,2,2-pentafluoroethyl 1,2,2-trifluoroethyl ether, hexafluoroethyl 1,2,2-trifluoroethyl ether, 1,1-difluoroethyl 2,2,2-trifluoroethyl ether, 1,2-difluoroethyl 2,2,2-trifluoroethyl ether, 2,2-difluoroethyl 2,2,2-trifluoroethyl ether, 1,1,1-trifluoroethyl 2,2,2-trifluoroethyl ether, 1,1,2-trifluoroethyl 2,2,2-trifluoroethyl ether, 1,2,2-trifluoroethyl 2,2,2-trifluoroethyl ether, di(2,2,2-trifluoroethyl) ether, 1,1,1,2-tetrafluoroethyl 2,2,2-trifluoroethyl ether, 1,1,2,2-tetrafluoroethyl 2,2,2-trifluoroethyl ether, 1,2,2,2-tetrafluoroethyl 2,2,2-trifluoroethyl ether, 1,1,1,2,2-pentafluoroethyl 2,2,2-trifluoroethyl ether, 1,1,2,2,2-pentafluoroethyl 2,2,2-trifluoroethyl ether, hexafluoroethyl 2,2,2-trifluoroethyl ether, 1,1-difluoroethyl 1,1,1,2-tetrafluoroethyl ether, 1,2-difluoroethyl 1,1,1,2-tetrafluoroethyl ether, 2,2-difluoroethyl 1,1,1,2-tetrafluoroethyl ether, 1,1,1-trifluoroethyl 1,1,1,2-tetrafluoroethyl ether, 1,1,2-trifluoroethyl 1,1,1,2-tetrafluoroethyl ether, 1,2,2-trifluoroethyl 1,1,1,2-tetrafluoroethyl ether, 2,2,2-trifluoroethyl 1,1,1,2-tetrafluoroethyl ether, di(1,1,1,2-tetrafluoroethyl) ether, 1,1,2,2-tetrafluoroethyl 1,1,1,2-tetrafluoroethyl ether, 1,2,2,2-tetrafluoroethyl 1,1,1,2-tetrafluoroethyl ether, 1,1,1,2,2-pentafluoroethyl 1,1,1,2-tetrafluoroethyl ether, 1,1,2,2,2-pentafluoroethyl 1,1,1,2-tetrafluoroethyl ether, hexafluoroethyl 1,1,1,2-tetrafluoroethyl ether, 1,1-difluoroethyl 1,1,2,2-tetrafluoroethyl ether, 1,2-difluoroethyl 1,1,2,2-tetrafluoroethyl ether, 2,2-difluoroethyl 1,1,2,2-tetrafluoroethyl ether, 1,1,1-trifluoroethyl 1,1,2,2-tetrafluoroethyl ether, 1,1,2-trifluoroethyl 1,1,2,2-tetrafluoroethyl ether, 1,2,2-trifluoroethyl 1,1,2,2-tetrafluoroethyl ether, 2,2,2-trifluoroethyl 1,1,2,2-tetrafluoroethyl ether, 1,1,1,2-tetrafluoroethyl 1,1,2,2-tetrafluoroethyl ether, di(1,1,2,2-tetrafluoroethyl) ether, 1,2,2,2-tetrafluoroethyl 1,1,2,2-tetrafluoroethyl ether, 1,1,1,2,2-pentafluoroethyl 1,1,2,2-tetrafluoroethyl ether, 1,1,2,2,2-pentafluoroethyl 1,1,2,2-tetrafluoroethyl ether, hexafluoroethyl 1,1,2,2-tetrafluoroethyl ether, 1,1-difluoroethyl 1,2,2,2-tetrafluoroethyl ether, 1,2-difluoroethyl 1,2,2,2-tetrafluoroethyl ether, 2,2-difluoroethyl 1,2,2,2-tetrafluoroethyl ether, 1,1,1-trifluoroethyl 1,2,2,2-tetrafluoroethyl ether, 1,1,2-trifluoroethyl 1,2,2,2-tetrafluoroethyl ether, 1,2,2-trifluoroethyl 1,2,2,2-tetrafluoroethyl ether, 2,2,2-trifluoroethyl 1,2,2,2-tetrafluoroethyl ether, 1,1,1,2-tetrafluoroethyl 1,2,2,2-tetrafluoroethyl ether, 1,1,2,2-tetrafluoroethyl 1,2,2,2-tetrafluoroethyl ether, di(1,2,2,2-tetrafluoroethyl) ether, 1,1,1,2,2-pentafluoroethyl 1,2,2,2-tetrafluoroethyl ether, 1,1,2,2,2-pentafluoroethyl 1,2,2,2-tetrafluoroethyl ether, hexafluoroethyl 1,2,2,2-tetrafluoroethyl ether, 1,1-difluoroethyl 1,1,1,2,2-pentafluoroethyl ether, 1,2-difluoroethyl 1,1,1,2,2-pentafluoroethyl ether, 2,2-difluoroethyl 1,1,1,2,2-pentafluoroethyl ether, 1,1,1-trifluoroethyl 1,1,1,2,2-pentafluoroethyl ether, 1,1,2-trifluoroethyl 1,1,1,2,2-pentafluoroethyl ether, 1,2,2-trifluoroethyl 1,1,1,2,2-pentafluoroethyl ether, 2,2,2-trifluoroethyl 1,1,1,2,2-pentafluoroethyl ether, 1,1,1,2-tetrafluoroethyl 1,1,1,2,2-pentafluoroethyl ether, 1,1,2,2-tetrafluoroethyl 1,1,1,2,2-pentafluoroethyl ether, 1,2,2,2-tetrafluoroethyl 1,1,1,2,2-pentafluoroethyl ether, di(1,1,1,2,2-pentafluoroethyl) ether, 1,1,2,2,2-pentafluoroethyl 1,1,1,2,2-pentafluoroethyl ether, hexafluoroethyl 1,1,1,2,2-pentafluoroethyl ether, 1,1-difluoroethyl 1,1,2,2,2-pentafluoroethyl ether, 1,2-difluoroethyl 1,1,2,2,2-pentafluoroethyl ether, 2,2-difluoroethyl 1,1,2,2,2-pentafluoroethyl ether, 1,1,1-trifluoroethyl 1,1,2,2,2-pentafluoroethyl ether, 1,1,2-trifluoroethyl 1,1,2,2,2-pentafluoroethyl ether, 1,2,2-trifluoroethyl 1,1,2,2,2-pentafluoroethyl ether, 2,2,2-trifluoroethyl 1,1,2,2,2-pentafluoroethyl ether, 1,1,1,2-tetrafluoroethyl 1,1,2,2,2-pentafluoroethyl ether, 1,1,2,2-tetrafluoroethyl 1,1,2,2,2-pentafluoroethyl ether, 1,2,2,2-tetrafluoroethyl 1,1,2,2,2-pentafluoroethyl ether, 1,1,1,2,2-pentafluoroethyl 1,1,2,2,2-pentafluoroethyl ether, di(1,1,2,2,2-penta fluoroethyl) ether, hexafluoroethyl 1,1,1,2,2-pentafluoroethyl ether, and dihexafluoroethyl ether; and
a group consisting of sulfate-based compounds such as bis(fluoromethyl) sulfate, bis(2-fluoroethyl)sulfate, bis(3-fluoropropyl) sulfate, bis(difluoromethyl) sulfate, bis(2,2-difluoroethyl) sulfate, bis(3,3-difluoropropyl) sulfate, bis(trifluoromethyl) sulfate, bis(2,2,2-trifluoroethyl) sulfate, bis(3,3,3-trifluoropropyl) sulfate, methyl(fluoromethyl) sulfate, methyl(2-fluoroethyl) sulfate, methyl(3-fluoropropyl) sulfate, methyl(difluoromethyl) sulfate, methyl(2,2-difluoroethyl) sulfate, methyl(3,3-difluoropropyl) sulfate, methyl(trifluoromethyl) sulfate, methyl(2,2,2-trifluoroethyl) sulfate, methyl(3,3,3-trifluoropropyl) sulfate, ethyl(fluoromethyl) sulfate, ethyl(2-fluoroethyl) sulfate, ethyl(3-fluoropropyl) sulfate, ethyl(difluoromethyl) sulfate, ethyl(2,2-difluoroethyl) sulfate, ethyl(3,3-difluoropropyl) sulfate, ethyl(trifluoromethyl) sulfate, ethyl(2,2,2-trifluoroethyl) sulfate, ethyl(3,3,3-trifluoropropyl) sulfate, propyl(fluoromethyl) sulfate, propyl(2-fluoroethyl) sulfate, propyl(3-fluoropropyl) sulfate, propyl(difluoromethyl) sulfate, propyl(2,2-difluoroethyl) sulfate, propyl(3,3-difluoropropyl) sulfate, propyl(trifluoromethyl) sulfate, propyl(2,2,2-trifluoroethyl) sulfate, propyl(3,3,3-trifluoropropyl) sulfate, (fluoromethyl)(2-fluoroethyl) sulfate, (fluoromethyl)(3-fluoropropyl) sulfate, (fluoromethyl)(difluoromethyl) sulfate, (fluoromethyl)(2,2-difluoroethyl) sulfate, (fluoromethyl)(3,3-difluoropropyl) sulfate, (fluoromethyl)(trifluoromethyl) sulfate, (fluoromethyl)(2,2,2-trifluoroethyl) sulfate, (fluoromethyl)(3,3,3-trifluoropropyl) sulfate, (2-fluoroethyl)(3-fluoropropyl) sulfate, (2-fluoroethyl)(difluoromethyl) sulfate, (2-fluoroethyl)(2,2-difluoroethyl) sulfate, (2-fluoroethyl)(3,3-difluoropropyl) sulfate, (2-fluoroethyl)(trifluoromethyl) sulfate, (2-fluoroethyl)(2,2,2-trifluoroethyl) sulfate, (2-fluoroethyl)(3,3,3-trifluoropropyl) sulfate, (3-fluoropropyl)(difluoromethyl) sulfate, (3-fluoropropyl)(2,2-difluoroethyl) sulfate, (3-fluoropropyl)(3,3-difluoropropyl) sulfate, (3-fluoropropyl)(trifluoromethyl) sulfate, (3-fluoropropyl)(2,2,2-trifluoroethyl) sulfate, (3-fluoropropyl)(3,3,3-trifluoropropyl) sulfate, (difluoromethyl)(2,2-difluoroethyl) sulfate, (difluoromethyl)(3,3-difluoropropyl) sulfate, (difluoromethyl)(trifluoromethyl) sulfate, (difluoromethyl)(2,2,2-trifluoroethyl) sulfate, (difluoromethyl)(3,3,3-trifluoropropyl) sulfate, (2,2-difluoroethyl)(3,3-difluoropropyl) sulfate, (2,2-difluoroethyl)(trifluoromethyl) sulfate, (2,2-difluoroethyl)(2,2,2-trifluoroethyl) sulfate, (2,2-difluoroethyl)(3,3,3-trifluoropropyl) sulfate, (3,3-difluoropropyl)trifluoromethyl) sulfate, (3,3-difluoropropyl)(2,2,2-trifluoroethyl) sulfate, and (3,3-difluoropropyl)(3,3,3-trifluoropropyl) sulfate,
although it may not be necessarily limited thereto.

The mixed organic solvent may further contain an additive.

The additive may serve to assist in the formation of a cathode-electrolyte interface (CEI). Specifically, it may be any one or two or more selected from a group consisting of boron series such as trimethyl boroxine (TMB), triethyl boroxine, trimethyl borate, triethyl borate (TEB), tris(trimethylsilyl) borate (TMSB), lithium trifluoro(perfluoro-tert-butyloxyl) borate (LiTPBOB), and lithium difluoro(oxalato) borate (LiDFOB); a group consisting of sulfur series such as 4,4-bi(1,3,2-dioxathiolane)2,2-dioxide (BDTD) and 2-(2,2,2-trifluoroethoxy)-1,3,2-dioxaphospholane-2-oxide (TFEOP); and a group consisting of fluorinated series which include methyl 2,2,2-trifluoroethyl carbonate (FEMC), methyl difluoroacetate (DFMAc), ethyl difluoroacetate (DFEAc), etc. or are added in combination with fluoroethylene carbonate (FEC), but is not necessarily limited thereto, and is not particularly limited as long as it is a previously known additive that assists in the formation of CEI.

The additive may serve to directly form or assist a solid-electrolyte interface (SEI). Specifically, it may be any one or two or more selected from a group consisting of cyclic compounds such as fluoroethylene carbonate (FEC), vinylene carbonate (VC), vinyl ethylene carbonate (VEC), allyl ethyl carbonate, vinyl acetate, divinyl adipate, acrylic acid nitrile, 2-vinyl pyridine, γ-butyrolactone (GBL), methylphenyl carbonate, succinic imide, maleic anhydride, methyl chloroformate, methyl cinnamate, and furan derivatives having double bonds; a group consisting of phosphonate compounds; a group consisting of vinyl-containing silane compounds; and a group consisting of nitrate and nitrite compounds, but is not necessarily limited thereto, and is not particularly limited as long as it is a previously known additive that forms or assists in the formation of SEI.

The additive may serve to remove active materials such as HF and PF₅. Specifically, it may be any one or two or more selected from a group having an isocyanate (N═C═O) functional group such as p-toluene sulfonyl isocyanate (PTSI); a group of pyrrolidinones such as 1-methyl-2-pyrrolidinone; a group consisting of silane derivatives having a Si—O structure, such as dimethoxy dimethyl silane (DODSi) and diphenyl dimethoxy silane (DPDMS); a group consisting of phosphoramides such as hexamethyl phosphoramide; a group consisting of phosphites such as tris(2,2,2-trifluoroethyl) phosphite and tris(trimethylsilyl) phosphite (TMSPi); and a group consisting of phosphonites such as diethyl phenyl phosphonite (DEPP), but is not necessarily limited thereto, and is not particularly limited as long as it is a previously known additive that removes active materials.

The additive may serve to prevent overcharging. Specifically, it may be any one or two or more selected from a group consisting of organic compounds such as metallocenes, tetracyano ethylene, tetramethyl phenylene diamine, dihydrophenazine, bipyridyl carbonates, biphenyl carbonates, 2,7-diacetyl thianthrene, and phenothiazine; a group consisting of lithium salts such as lithium fluorododecaborates (Li₂B₁₂FₓH₁₂₋ₓ) and lithium bis(oxalato)borate (LiBOB); and a group consisting of aromatic compounds such as xylene, cyclohexyl benzene, hexaethyl benzene, biphenyl, 2,2-diphenyl propane, 2,5-di-tert-butyl-1,4-dimethoxy benzene, phenyl-tert-butyl carbonate, anisole, difluoroanisole, and thiophene-3-acetonitrile, but is not necessarily limited thereto, and is not particularly limited as long as it is a previously known additive that prevents overcharging.

The additive may be added to increase flame retardancy of the secondary battery. Specifically, it may be any one or two or more selected from a group consisting of alkyl phosphates such as trimethyl phosphate and triethyl phosphate; a group consisting of halogenated phosphates such as tris(2,2,2-trifluoroethyl) phosphate; a group consisting of phosphazenes such as hexamethoxy cyclophosphazene; and a group consisting of fluorinated ethers and fluorinated carbonates such as methyl nonafluorobutyl ether (MFE) and fluoropropylene carbonate, but is not necessarily limited thereto, and is not particularly limited as long as it is a previously known additive that increases flame retardancy.

The additive may be added for uniform reduction deposition of lithium. Specifically, it may be any one or two or more selected from tetrahydrofuran, 2-methyltetrahydrofuran, thiophene, 2-methylthiophene, nitromethane, tetraalkylammonium chloride, cetyltrimethylammonium chloride, lithium perfluorooctane sulfonate, tetraethylammonium perfluorooctane sulfonate, perfluoropolyethers, AlI₃, SnI₂, etc.

The additive may be added to help a solvation phenomenon of ions. Specifically, it may be any one or two or more selected from 12-crown-4 and its derivatives, tris(pentafluorophenyl)borane, cyclic aza-ether compounds, borole compounds, etc.

The additive may be added to prevent corrosion of an aluminum current collector. Specifically, it may include lithium salt compounds having a chemical formula of LiN(SO₂CₙF₂ₙ₊₁)₂ (n=2 to 4).

The content of the additive may be adjusted within a range of 0.01 to 10% by weight depending on desired physical properties.

The concentration of an electrolyte composed of a mixed organic solvent containing the lithium salts may be adjusted to a level commonly used in the art, and specifically for example, the concentration of the lithium salts may be 0.1 to 60 M, more preferably 0.5 to 2 M.

The electrolyte may include the polymer electrolyte matrix to improve mechanical properties or high-temperature stability of the battery. Specifically, it may be any one or mixtures of two or more selected from the group consisting of polymers such as polyacrylate, polymethacrylate, polyvinylidene fluoride (PVDF), polyhexafluoropropylene (PHFP), polyethylene oxide (PEO), polypropylene oxide (PPO), polydimethyl siloxane, polyacrylonitrile, polyvinyl chloride (PVC) and PEGDME, and copolymers mixed therewith, and is not limited as long as it is a previously known polymer material for lithium secondary batteries.

The polymer matrix may include crosslinking units for crosslinking each other.

The all-solid electrolyte is a composite of the polymer matrix and the lithium salt, and is a form in which these are mixed, and the components constituting them are the same as those of the above-described polymer matrix and the lithium salt so that overlapping descriptions are omitted.

The separator may be a porous polymer film that is any one of polyethylene and polypropylene; or a porous polymer film coated with a ceramic material.

The lithium secondary battery may be manufactured in various shapes such as a prismatic shape, a cylindrical shape, a coin shape, or a pouch shape.

The lithium secondary battery may be a lithium ion secondary battery, a lithium polymer secondary battery, or a lithium all-solid secondary battery, and may be used in wearable electronic devices, power tools, and energy storage systems (ESSs). In particular, it is suitable for use in electric vehicles (EVs) with high value of high-speed charging technology, portable electronic devices such as smartphones, electric two-wheeled vehicles such as electric bicycles and electric scooters, drones, electric airplanes, or electric golf carts.

The graphite active material may be used as a cathode material of a dual ion battery (DIB). At this time, the graphite active material intercalates and stores anions included in the electrolyte during battery charging, and deintercalates anions during battery discharging.

The dual ion battery may further include: an aluminum anode; an electrolyte for a dual ion battery; and a separator.

Lithium is reduced and precipitated on the surface of the aluminum anode during charging, and lithium is oxidized during discharging to release electrical energy.

Since the composition of the electrolyte for a dual ion battery is the same as that of the above-described electrolyte for a lithium secondary battery, overlapping descriptions will be omitted.

Since the separator is the same as described above, overlapping descriptions will be omitted.

Hereinafter, a graphite active material according to the present invention and a high-capacity secondary battery for high-speed charging/discharging including the same will be described in more detail through Examples. However, the following Examples are only one reference for explaining the present invention in detail, but the present invention is not limited thereto, and may be implemented in various forms.

Further, unless defined otherwise, all technical and scientific terms have the same meaning as commonly understood by one of ordinary skill in the art to which the present invention belongs. The terms used in the description in the present application are merely to effectively describe specific embodiments and are not intended to limit the present invention. In addition, the unit of additives not specifically described in the specification may be % by weight.

### [Methods of Evaluating Characteristics]

### 1) Measurement of Interlayer Distances Door of Active Materials

The interlayer distances door of the graphite electrode active materials were measured through X-ray diffraction (XRD) and are shown in Table 1.

### 2) Measurement of Specific Surface Areas of Active Materials

The specific surface areas of the graphite electrode active materials were measured through Brunauer-Emmett-Teller (BET) and are shown in Table 1.

### 3) Charge and Discharge Test 1:

Manufactured were coin-type lithium secondary batteries composed of electrodes prepared in Examples 1 to 5 and Comparative Examples 1 to 2, a lithium metal electrode, a 1.0M LiPF₆/EC:EMC (volume ratio of 3:7) electrolyte solution that did not contain an additive, and a separator.

A low-speed (0.1 C) charge/discharge cycle was performed five times in a voltage range of 0.01 to 1.5 V. The cycle included performing charging up to 0.01 V with CC of 0.1 C-rate under constant current (CC)/constant voltage (CV) charging and CC discharging conditions, then performing charging with CV until the current reached 0.005 C, and performing discharging to 1.5 V under CC conditions. In the charge and discharge cycles, the specific gravimetric capacity and Coulombic efficiency of the lithium secondary battery during low-speed charging and discharging were measured and are shown in Table 2.

In addition, the 0.1 C discharge capacity/theoretical capacity (%) was calculated according to Calculation Formula 1 below.

0.1 C discharge capacity/theoretical capacity (%)=(capacity during 0.1 C charging and discharging/theoretical capacity (372 mAh/g))×100 [Calculation Formula 1]

0.1 C discharge capacity/theoretical capacities (%) calculated according to the above calculation formula are shown in Table 2.

### 4) Charge and Discharge Test 2:

Manufactured were coin-type lithium secondary batteries composed of electrodes prepared in Examples 1 to 5 and Comparative Examples 1 to 2, a lithium metal electrode, a 1.0M LiPF₆/EC:EMC (volume ratio of 3:7) electrolyte solution that did not contain an additive, and a separator.

The charge/discharge cycle was performed three times at 0.2 to 2 C-rate in a voltage range of 0.01 to 1.5 V. The cycle included performing charging up to 0.01 V with a CC of 0.2 to 2 C-rate under constant current (CC)/constant voltage (CV) charging and CC discharging conditions, then performing charging with CV until the current reached 0.05 times the C-rate inputted during CC charging, and performing discharging to 1.5 V under CC conditions with the same current as the C-rate during charging. Discharge capacities were measured by performing charge and discharge cycles at 0.2 to 2 C in the 0.01 to 1.5 V voltage range.

In addition, the capacity retention rate was calculated according to Calculation Formula 2 below.

Capacity retention (%)=(discharge capacity according to C-rate/0.1 C discharge capacity)×100 [Calculation Formula 2]

The capacity retention rates according to the results of charge and discharge test 2 were calculated and are shown in Table 3.

### 5) Charge and Discharge Test 3:

Manufactured were coin-type lithium secondary batteries composed of electrodes prepared in Examples 4 to 5 and Comparative Example 2, a lithium metal electrode, a 1.0M LiPF₆/EC:EMC (volume ratio of 3:7) electrolyte solution that did not contain an additive, and a separator.

A low-speed (0.1 C) charge/discharge cycle was performed three times in a voltage range of 0.01 to 1.5 V. The cycle included performing charging up to 0.01 V with CC of 0.1 C-rate under constant current (CC)/constant voltage (CV) charging and CC discharging conditions, then performing charging with CV until the current reached 0.005 C, and performing discharging to 1.5 V under CC conditions. The discharge capacity was measured by performing the charge and discharge cycle 100 times at 1 C in the voltage range of 0.01 to 1.5 V. The specific gravimetric capacities of the lithium secondary battery were measured at the first and 100th charge/discharge cycles of 1 C and are shown in Table 4.

In addition, the capacity retention rate was calculated according to Calculation Formula 3 below.

Capacity retention (%)=(100^{th} discharge capacity/1^{st} discharge capacity)×100 [Calculation Formula 3]

### 6) Charge and Discharge Test 4:

Manufactured were coin-type lithium secondary batteries composed of electrodes prepared in Examples 1 to 3 and Comparative Example 1, a lithium metal electrode, a 1.0M LiPF₆/propylene carbonate (PC):di-(2,2,2trifluoroethyl)carbonate (DFDEC) (volume ratio of 3:7) electrolyte solution that did not contain an additive, and a separator.

The charge/discharge cycle was performed three times at 0.2 to 2 C-rate in a voltage range of 0.01 to 1.5 V. The cycle included performing charging up to 0.01 V with a CC of 0.2 to 2 C-rate under constant current (CC)/constant voltage (CV) charging and CC discharging conditions, then performing charging with CV until the current reached 0.05 times the C-rate inputted during CC charging, and performing discharging to 1.5 V under CC conditions with the same current as the C-rate during charging. Discharge capacities were measured by performing charge and discharge cycles at 0.2 to 2 C in the 0.01 to 1.5 V voltage range.

In addition, the capacity retention rate was calculated according to Calculation Formula 2 above.

### Example 1

A graphite electrode using artificial graphite as an electrode active material was prepared. The graphite electrode was supported in ethyl methyl carbonate (EMC) and treated at −20° C. for 24 hours.

### Example 2

All processes were performed in the same manner as in Example 1 except that the treatment time was changed depending on the items shown in Table 1 below.

### Example 3

All processes were performed in the same manner as in Example 1 except that the supporting organic solvent was changed as shown in Table 1 below instead of EMC, and the treatment time was changed to 48 hours.

### Example 4

A graphite electrode using natural graphite as an electrode active material was prepared. The graphite electrode was supported in ethyl methyl carbonate (EMC) and treated at −20° C. for 48 hours.

### Example 5

A graphite electrode using natural graphite as an electrode active material was prepared. The graphite electrode was supported in ethanol and treated at −20° ° C. for 48 hours.

### Comparative Example 1

A graphite electrode using artificial graphite which had not been subjected to pretreatment as an active material was prepared.

### Comparative Example 2

A graphite electrode using natural graphite which had not been subjected to pretreatment as an active material was prepared.

Organic solvents having Examples 1 to 5 and Comparative Examples 1 to 2 supported therein, treatment time, and interlayer distance were measured and are shown in Table 1. In addition, after manufacturing lithium half-cells including these, a formation process was performed and the discharge capacity per weight of the graphite electrode, discharge capacity compared to theoretical capacity, and initial Coulombic efficiency were calculated based on 0.1 C charging and discharging, and are shown in Table 2.

TABLE 1

| | | | | Interlayer | BET specific |
|---|---|---|---|---|---|
| | Graphite | Organic | Treatment | distance | surface area |
| | type | solvent | time (hr) | (Å) | (m²/g) |
| Comparative | Artificial | — | — | 3.367 | 2.095 |
| Example 1 | graphite | | | | |
| Example 1 | | EMC | 24 | 3.368 | — |
| Example 2 | | EMC | 48 | 3.370 | 2.677 |
| Example 3 | | Ethanol | 48 | 3.370 | — |
| Comparative | Natural | — | — | 3.360 | 3.446 |
| Example 2 | graphite | | | | |
| Example 4 | | EMC | 48 | 3.362 | 4.436 |
| Example 5 | | Ethanol | 48 | 3.363 | 5.064 |

TABLE 2

| | Discharge capacity | 0.1 C discharge | Initial |
|---|---|---|---|
| | per weight (0.1 | capacity/theoretical | Coulombic |
| | C)(mAh/g) | capacity (%) | efficiency (%) |
| Comparative | 327 | 87.9 | 61.0 |
| Example 1 | | | |
| Example 1 | 338 | 90.9 | 75.2 |
| Example 2 | 355 | 95.4 | 85.3 |
| Example 3 | 351 | 94.4 | 76.2 |
| Comparative | 353 | 94.9 | 88.5 |
| Example 2 | | | |
| Example 4 | 385 | 103.5 | 90.9 |
| Example 5 | 390 | 104.8 | 93.0 |

### A. Artificial Graphite Electrode

As can be seen through Table 2, Examples 1 to 3 using artificial graphite anode active materials satisfied the organic solvent conditions and treatment conditions (treatment at −40 to 0° C. for 0.1 to 168 hours) suggested in the present invention so that, as can be seen through Table 1, the discharge capacities per weight were 338 to 355 mAh/g, and the discharge capacities per weight corresponding to 90.9 to 95.4% of the theoretical capacity could be obtained.

In addition, the initial coulombic efficiencies of Examples 1 to 3 were 75.2 to 85.3%, which had the effect of suppressing the generation of irreversible capacity, and thus an initial battery capacity reduction phenomenon could be prevented.

Particularly preferably, the organic solvent most advantageous for the artificial graphite anode in the present invention is ethyl methyl carbonate (EMC), and treatment is preferably performed for 36 to 60 hours.

Meanwhile, in the case of Comparative Example 1 which had not been subjected to pretreatment, the discharge capacity per weight was 327 mAh/g, which is only 87.9% of the theoretical capacity, and the initial Coulombic efficiency of Comparative Example 1 was 61.0%, Comparative Example 1 had a lower efficiency than that of the present invention since a maximum capacity reduction phenomenon of the battery was appeared due to the large irreversible capacity.

### B. Natural Graphite Electrode

As can be seen through Table 2 above, Example 4 using a natural graphite anode active material satisfied the organic solvent conditions and treatment conditions presented in the present invention so that, as can be seen through Table 1 above, the interlayer distance was increased, the discharge capacity per weight was 385 mAh/g, and the capacity increase effect corresponding to 103.5% of the theoretical capacity could be obtained. In addition, the initial Coulombic efficiency of Example 4 was 90.9%, which is effective in preventing a reduction in battery capacity by reducing irreversible reactions.

In addition, Example 5 satisfied the organic solvent conditions and treatment conditions presented in the present invention so that, as can be seen through Table 1 above, the interlayer distance increased, the discharge capacity per weight was 390 mAh/g, and the capacity increase effect corresponding to 104.8% of the theoretical capacity could be obtained. In addition, the initial Coulombic efficiency of Example 5 was 93.0%, which is effective in preventing a reduction in battery capacity by reducing irreversible reactions.

In the present invention, the organic solvent that is advantageous to the natural graphite electrode is EMC or ethanol, and it is particularly preferable to use ethanol. Additionally, it is preferable to support the natural graphite electrode in the organic solvent and treat it for 36 to 60 hours.

Meanwhile, during 0.1 C charging and discharging of Comparative Example 2 which had not been subjected to pretreatment, the discharge capacity per weight was 353 mAh/g, showing the performance of 94.9% compared to the theoretical capacity, which is the same as the performance of generally known natural graphite, and the initial Coulombic efficiency was also not good compared to the present invention.

TABLE 3

Capacity retention (%)

| | 0.2 C | 0.5 C | 1 C | 2 C |
|---|---|---|---|---|
| Comparative | 95 | 74 | 37 | 13 |
| Example 1 | | | | |
| Example 1 | 96 | 69 | 36 | 13 |
| Example 2 | 98 | 88 | 56 | 24 |
| Example 3 | 97 | 84 | 50 | 21 |
| Comparative | 97 | 84 | 57 | 32 |
| Example 2 | | | | |
| Example 4 | 98 | 89 | 63 | 42 |
| Example 5 | 99.8 | 99.7 | 99.6 | 99.0 |

As can be seen through Table 3, the high-speed charging performance was most significantly improved in Examples 1 to 3 according to the present invention when the treatment times of being supported in the organic solvent were 36 to 60 hours. In addition, the high-speed charging performance was improved as described above also in Examples 4 and 5 so that it can be confirmed that the present invention has an effect for both artificial graphite and natural graphite, and especially for natural graphite.

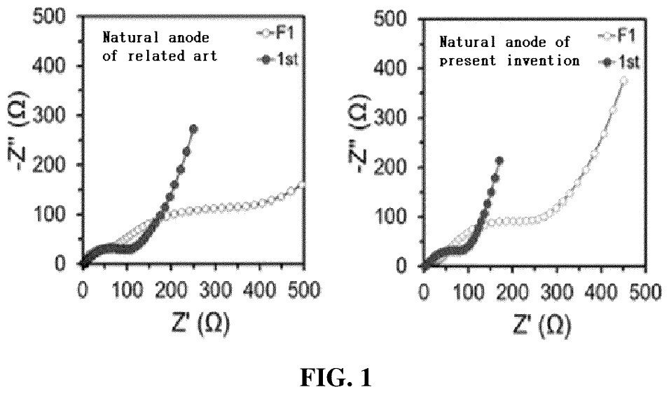

More specifically, as can be seen in FIG. 1, in Example 5, the formation process interface resistance was reduced and the increase in initial cycle interface resistance was also suppressed so that it can be confirmed that these functions contributed to the improvement of high-speed charging and discharging performance.

TABLE 4

| | 1 C (1 hour charging) charging and | | |
|---|---|---|---|
| | discharging cycle performance | | |
| | 1^{st} discharge | 100^{th} discharge | Capacity |
| | capacity | capacity | retention (%) |
| Comparative | 371 | Inoperative | — |
| Example 2 | | | |
| Example 5 | 388 | 371 | 95.6 |

As can be seen through Table 4, cycle operation was not possible under high-speed charging and discharging conditions in Comparative Example 2. On the other hand, the capacity retention was very high by exceeding 95% after 100 cycles of high-speed charging and discharging in Example 5 according to the present invention. It can be confirmed that the present invention has a great effect in improving high-speed charging performance.

### Example 6

After manufacturing a lithium half-cell including a graphite electrode using artificial graphite prepared in Example 2 as an electrode active material, a formation process was performed, and thus the discharge capacity per weight of the graphite electrode, the discharge capacity compared to theoretical capacity, and the initial Coulombic efficiency were calculated based on 0.1 C charging and discharging and are shown in Table 5.

TABLE 5

Capacity retention (%)

| | 0.2 C | 0.5 C | 1 C | 2 C |
|---|---|---|---|---|
| Comparative | 95 | 74 | 37 | 13 |
| Example 1 | | | | |
| Example 2 | 98 | 88 | 56 | 24 |
| Example 6 | 99 | 96 | 85 | 40 |

As shown in Table 5, the high-speed charging is equally possible not only in the commercial electrolyte solution of Example 2 but also in the electrolyte solution containing the fluorinated solvent of Example 10 according to the present invention. In particular, the high-speed charging and discharging performance at 0.5 C to 2 C was most significantly improved in the electrolyte solution containing the fluorinated solvent of Example 6 so that it can be confirmed that graphite of the present invention has a great effect in the electrolyte solution containing the fluorinated solvent.

Although preferred embodiments of the present invention have been described in detail above, the scope of rights of the present invention is not limited thereto, and various modifications and improved forms made by those skilled in the art using the basic concept of the present invention defined in the following claims also fall within the scope of the rights of the present invention.

### INDUSTRIAL APPLICABILITY

The present invention relates to a graphite active material, a method for preparing the same, and a high-capacity secondary battery for high-speed charging including the same.

1. A graphite active material having an interlayer distance d₀₀₂ increased by 0.001 Å to 0.003 Å.

2. The graphite active material of claim 1, wherein the graphite active material is a natural graphite active material or an artificial graphite active material.

3. The graphite active material of claim 2, wherein the lithium secondary battery comprising the natural graphite active material as an electrode active material has an initial Coulombic efficiency of 90 to 95%, a discharge capacity per weight of 360 mAh/g or more during 0.1 C charging, and a capacity retention rate of 30 to 99% during 2_C charging.

4. The graphite active material of claim 2, wherein the lithium secondary battery comprising the graphite active material as an electrode active material has a discharge capacity per weight of 320 mAh/g or more during 1 C (charging in 1 hour) charging, and enables a 1 C charge cycle.

5. The graphite active material of claim 2, wherein the artificial graphite active material has an interlayer distance d₀₀₂ of 3.368 Å to 3.370 Å.

6. The graphite active material of claim 5, wherein the lithium secondary battery comprising the artificial graphite active material as an electrode active material has an initial Coulombic efficiency of 65 to 92%, a discharge capacity per weight of 345 to 360 mAh/g during 0.1 C charging, and a capacity retention of 10 to 45% during 2_C charging (charging in 30 minutes).

7. The graphite active material of claim 1, wherein the graphite active material has a BET specific surface area increased by 127% or more.

8. An electrode for a secondary battery, comprising the graphite active material according to claim 1.

9. The electrode for a secondary battery of claim 8, wherein the electrode for a secondary battery is a cathode material or an anode material of the secondary battery.

10. A secondary battery comprising the electrode for a secondary battery according to claim 9.

11. A method for preparing a graphite active material, comprising the steps of:
supporting graphite in an organic solvent;
low-temperature treating graphite supported in the organic solvent; and
drying low-temperature treated graphite,
wherein the graphite active material has an interlayer distance d₀₀₂ increased by 0.001 Å to 0.003 Å.

12. The method of claim 11, wherein the organic solvent is selected from the group consisting of a linear alcohol-based organic solvent, a linear carbonate-based organic solvent, a cyclic carbonate-based organic solvent, a linear ester-based organic solvent, a ketone-based organic solvent, and mixtures thereof.

13. The method of claim 11, wherein the low-temperature treatment is performed at 0 to −40° ° C. for 0.1 to 168 hours.

14. An electrode for a secondary battery, comprising the graphite active material according to claim 2.

15. An electrode for a secondary battery, comprising the graphite active material according to claim 3.

16. An electrode for a secondary battery, comprising the graphite active material according to claim 4.

17. An electrode for a secondary battery, comprising the graphite active material according to claim 5.

18. An electrode for a secondary battery, comprising the graphite active material according to claim 6.

19. An electrode for a secondary battery, comprising the graphite active material according to claim 7.
